(19) United States
(12) Patent Application Publication
(10) Pub. No.: US 2026/0297258 A1
(43) Pub. Date: Oct. 1, 2026

(54) SURFACE FUNCTIONALIZED FOAMS AND METHODS OF USE THEREOF

(71) Applicant: ARIZONA BOARD OF REGENTS ON BEHALF OF ARIZONA STATE UNIVERSITY, Scottsdale, AZ (US)

(72) Inventors: Kamyar Karimi Nikoo, Tempe, AZ (US); Timothy Long, Phoenix, AZ (US); Cameron Pascoe, San Diego, CA (US)

(21) Appl. No.: 19/572,579

(22) Filed: Mar. 19, 2026

Related U.S. Application Data
(60) Provisional application No. 63/774,486, filed on Mar. 19, 2025.

(51) Int. Cl. C08G 71/04; C02F 1/40; C02F 101/32; C08J 9/40

(52) U.S. Cl. CPC C08G 71/04; C02F 1/40; C08J 9/40; C02F 2101/32; C02F 2303/16; C08J 2205/05; C08J 2205/052; C08J 2375/04

(57) ABSTRACT

The disclosure relates to functionalized polyurethane foams. The functionalized polyurethane foams described herein can be produced through the facile functionalization of post-consumer polyurethane foams such as those found in mattresses and furniture. The disclosure provides methods of producing foam functionalization compositions and methods of using functionalized polyurethane foam compositions. For example, the functionalized polyurethane foams can be used in oil remediation.

This application claims priority to U.S. Provisional Application No. 63/774,486 filed on Mar. 19, 2025, the entire contents of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records but otherwise reserves any and all copyright rights.

### FIELD OF THE INVENTION

The present invention relates to foam functionalization methods and compositions for increased absorption.

### BACKGROUND OF THE INVENTION

In the global market, polyurethanes (PU) are seeing a surge in popularity, particularly in the form of covalently crosslinked microcellular foams, known as polyurethane foams (PUF). These PUF materials have emerging applications in various crucial sectors such as construction, infrastructure, foam mattresses, and insulation. However, the growing demand for microcellular materials is contributing to a national crisis as PU foam waste continues to accumulate. Foam functionalization methods are intricate and often involve in-situ functionalization with foaming, which is not suitable for post-consumer PU foam waste.

### SUMMARY OF THE INVENTION

Aspects of the disclosure are drawn towards a modified polyurethane foam (PUF) comprising at least one urethane linkage functionalized with 2-(oxazolidine-3-yl), tetradecyl isocyanate, or a combination of 2-(oxazolidine-3-yl) and tetradecyl isocyanate. In embodiments, the foam is an “O-modified” PUF comprising at least one urethane linkage functionalized with 2 (oxazolidine-3-yl):

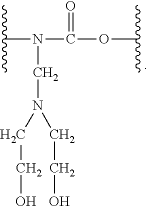 [SMILES: *OC(=O)N(*)CN(CCO)CCO]

In embodiments, the “O-modified” PUF comprises an oil absorption capacity of about 20.0 g/g to about 60.0 g/g and a water absorption capacity of about 15 g/g to about 40 g/g.

In embodiments, the foam is an “IL-modified” PUF comprising at least one urethane linkage functionalized with tetradecyl isocyanate:

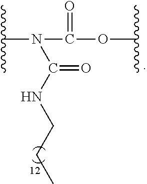 [SMILES: *OC(=O)N(*)C(=O)NCCC]

In embodiments, “IL-modified” PUF comprises an oil absorption capacity of about 10 g/g to about 35 g/g and a water absorption capacity of less than about 0.1 g/g to about 7.5 g/g.

In embodiments, the foam is an “ILO-modified” PUF comprising at least one urethane linkage functionalized with a combination of 2 (oxazolidine-3-yl) and tetradecyl isocyanate:

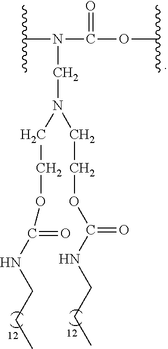 [SMILES: *OC(=O)N(*)CN(CCOC(=O)NCCC)CCOC(=O)NCCC]

In embodiments, the foam is an “ILO-modified” PUF comprises an oil absorption capacity of about 30 g/g to about 60 g/g; and a water absorption capacity of about 10 g/g to about 40 g/g.

In embodiments, the polyurethane is a post-consumer polyurethane. In embodiments, the foam is an open-cell foam or a closed-cell foam. In embodiments, the polyurethane is an aliphatic polyurethane or an aromatic polyurethane.

Aspects of the disclosure are drawn towards methods of functionalizing a polyurethane foam, the method comprising: submerging the foam in 2-(oxazolidine-3-yl) or tetradecyl isocyanate; and heating the submerged foam to about 50° C. to about 90° C. for about 0.5 hours to about 24 hours. In embodiments, the foam is a post-consumer foam. In embodiments, the polyurethane is an aliphatic polyurethane or an aromatic polyurethane. In embodiments, the foam is submerged in 2-(oxazolidine-3-yl), thereby producing an “O-modified” PUF comprising at least one urethane linkage functionalized with 2 (oxazolidine-3-yl):

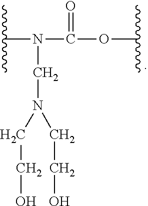 [SMILES: *OC(=O)N(*)CN(CCO)CCO]

In embodiments, the foam is submerged in tetradecyl isocyanate, thereby producing an “IL-modified” PUF comprising at least one urethane linkage functionalized with tetradecyl isocyanate:

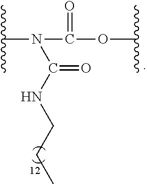 [SMILES: *OC(=O)N(*)C(=O)NCCC]

In embodiments, the method further comprises rinsing and drying the O-modified PUF; and submerging the foam in tetradecyl isocyanate, thereby producing an “ILO-modified” PUF comprising at least one urethane linkage functionalized with a combination of 2 (oxazolidine-3-yl) and tetradecyl isocyanate:

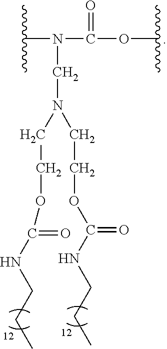

Aspects of the disclosure are drawn towards a method of oil remediation, the method comprising: submerging a surface-modified polyurethane foam (PUF) in a liquid composition comprising an oil, wherein the surface-modified PUF comprises a polyurethane foam functionalized with 2-(oxazolidine-3-yl), tetradecyl isocyanate, or a combination thereof; and removing the surface-modified PUF, thereby removing the oil from the liquid composition. In embodiments, the method further comprising compressing or squeezing the foam to release the oil from the foam, thereby reactivating the foam. In embodiments, the polyurethane foam is a post-consumer polyurethane foam. In embodiments, the post-consumer polyurethane foam is a mattress.

Other objects and advantages of this invention will become readily apparent from the ensuing description.

### BRIEF DESCRIPTION OF THE FIGURES

FIG. 1 shows a non-limiting, exemplary graphical illustration of PUF sample oil/water absorption test.

FIG. 2 shows non-limiting, exemplary oil/water absorption data and uptake properties of surface-modified PUFs. Oil/water absorption capacities of PUF samples demonstrate surface-modification.

FIG. 3 shows non-limiting, exemplary photographs of the oil/water separation process. The mineral oil/water separation process with the IL-modified PUF demonstrates its oleophilic properties. Red ink was added to the oil for clear observation.

FIG. 4A shows non-limiting, exemplary SEM images of the pristine PUF.

FIG. 4B shows non-limiting, exemplary SEM images of O-modified PUF.

FIG. 4C shows non-limiting, exemplary SEM images of IL-modified PUF.

FIG. 4D shows non-limiting, exemplary SEM images of ILO-modified PUF.

FIG. 5 shows non-limiting, exemplary elemental analysis. XPS indicates the change in the presence of different elements with different surface modification routes.

FIG. 6 shows non-limiting, exemplary TGA results of the pristine and surface-modified PUFs.

FIG. 7 shows non-limiting, exemplary a ¹H NMR spectrum of synthesized 2-(oxazolidin-3-yl) ethanol.

FIG. 8 shows non-limiting, exemplary XPS spectra. XPS analysis indicates silylation of the O-modified PUFs. The silicon (Si) content on the PUF surface increased from 5.75% to 8.10% after the silylation process, indicating the addition of silyl groups.

FIG. 9 shows non-limiting, exemplary graphs of oil/water uptake tests. Oil/water uptake tests on the silylated O-modified PUFs showed lower hydrophilicity compared to O-modified samples due to the presence of non-polar groups on the surface of the foam.

FIG. 10 shows a non-limiting, exemplary illustration of modified PUF as described herein.

FIG. 11 shows a non-limiting, exemplary illustration of the synthesis of IL-, O-, and ILO-modified PUF.

FIG. 12 shows background methods on a model compound.

### DETAILED DESCRIPTION OF THE INVENTION

Detailed descriptions of one or more embodiments are provided herein. It is to be understood, however, that the invention can be embodied in various forms. Therefore, specific details disclosed herein are not to be interpreted as limiting, but rather as a basis for the claims and as a representative basis for teaching one skilled in the art to employ the invention in any appropriate manner.

The singular forms “a”, “an” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower). In embodiments, the term “about” can be denoted by “~”.

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, it is to be understood that the disclosure is not necessarily limited in its application to the details set forth in the following description or exemplified by the examples. The disclosure can be used for other embodiments or of being practiced or carried out in various ways. Other compositions, compounds, methods, features, and advantages of the disclosure will be or become apparent to one having ordinary skill in the art upon examination of the following drawings, detailed description, and examples. All such additional compositions, compounds, methods, features, and advantages can be included within this description, and be within the scope of the disclosure.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some embodiments, a straight chain or branched chain alkyl has 30 or fewer carbon atoms in its backbone (e.g., C₁-C₃₀ for straight chains, C₃-C₃₀ for branched chains), 20 or fewer, 12 or fewer, or 7 or fewer. Likewise, in some embodiments cycloalkyls have from 3-10 carbon atoms in their ring structure, e.g., have 5, 6 or 7 carbons in the ring structure. The term “alkyl” (or “lower alkyl”) as used throughout the specification, examples, and claims can include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein can refer to an alkyl group, as defined herein, but having from one to ten carbons, or from one to six carbon atoms in its backbone structure. Likewise, “lower alkenyl” and “lower alkynyl” have similar chain lengths. In some embodiments, alkyl groups are lower alkyls. In some embodiments, a substituent described herein as alkyl can be a lower alkyl.

It will be understood by those skilled in the art that the moieties substituted on the hydrocarbon chain can themselves be substituted, if appropriate. For instance, the substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined herein for alkyl groups.

The term “alkylthio” refers to an alkyl group, as defined herein, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined herein for alkyl groups.

The terms “alkenyl” and “alkynyl”, refer to unsaturated aliphatic groups analogous in length and possible substitution to the alkyls described herein, but that contain at least one double or triple bond respectively. For example,

The terms “alkoxyl” or “alkoxy” as used herein refers to an alkyl group, as defined herein, having an oxygen radical attached thereto. Representative alkoxyl groups include methoxy, ethoxy, propyloxy, and tert-butoxy. An “ether,” for example, can be two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined herein. The alkoxy and aroxy groups can be substituted as described herein for alkyl.

The terms “amine” and “amino” are art-recognized and refer to both unsubstituted and substituted amines, e.g., a moiety that can be represented by the general formula:

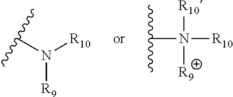

wherein R₉, R₁₀, and R₁₀, each independently represent a hydrogen, an alkyl, an alkenyl, —(CH₂)ₘ-Rs or R₉ and R₁₀ taken together with the N atom to which they are attached complete a heterocycle having from 4 to 8 atoms in the ring structure; Rs represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R. and R₁₀ represents a carbonyl. In additional embodiments, R₉ and R₁₀ (and optionally R₁₀) each independently represent a hydrogen, an alkyl or cycloalkyl, an alkenyl or cycloalkenyl, or alkynyl. Thus, the term “alkylamine” as used herein can refer to an amine group, as defined herein, having a substituted (as described hereinfor alkyl) or unsubstituted alkyl attached thereto, i.e., at least one of R₉ and R₁₀ is an alkyl group.

As used herein, the term “imide” can refer to —C(O) NR′R″, wherein R′ and R″ are each independently hydrogen, or a substituted or unsubstituted alkyl, cycloalkyl, alkenyl, alkynyl, aryl aralkyl, heterocyclyl or heterocyclylalkyl group as defined herein.

As used herein, the term “halogen” can refer to —F, —Cl, —Br or —I; the term “sulfhydryl” can refer to —SH; the term “hydroxyl” can refer to —OH; and the term “sulfonyl” can refer to —SO₂—.

The term “substituted” as used herein, refers to permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, for example 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, amino acid, peptide, and polypeptide groups. As used herein in reference to an “R” group, the name used to describe said “R” group can be the chemical name prior to the removal of a hydrogen. For example, wherein “R” is described as an “alkane” can refer to an “alkyl” group.

Heteroatoms such as nitrogen can have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen can have hydrogen substituents and/or any permissible substituents of organic compounds described herein which satisfy the valencies of the heteroatoms.

In various aspects, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

As used herein, the term “monomer” can refer to any discreet chemical compound of any molecular weight. As used herein, the term “co-monomer” can refer to a polymerizable precursor to a co-polymer in addition to a first monomer. For example, the reaction with co-monomers can produce a copolymer. The term “copolymer” as used herein, can refer to a single polymeric material that is comprised of two or more different monomers. The copolymer can be of any form, such as gradient, random, block, graft, etc. The copolymers can have any end-group.

As used herein, the term “polymer” refers to a molecule composed of repeating structural units typically connected by covalent chemical bonds. The term “polymer” is also meant to include the terms copolymer and oligomers. In certain embodiments, a polymer comprises a backbone (i.e., the chemical connectivity that defines the central chain of the polymer, including chemical linkages among the various polymerized monomeric units) and a side chain (i.e., the chemical connectivity that extends away from the backbone).

As used herein, the term “polymerization” can refer to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combinations thereof. A polymerization reaction can consume between about 0% and about 100% of the at least one functional group available in the system. In certain embodiments, polymerization or crosslinking of at least one functional group results in about 100% consumption of the at least one functional group. In other embodiments, polymerization or crosslinking of at least one functional group results in less than about 100% consumption of at least one functional group.

As used herein, the term “reaction condition” can refer to a physical treatment, chemical reagent, or combination thereof, which is required or optionally required to promote a reaction. Non-limiting examples of reaction conditions are electromagnetic radiation (such as, but not limited to, visible light and UV light), heat, a catalyst, a chemical reagent (such as, but not limited to, an acid, base, electrophile or nucleophile), and a buffer. Reaction conditions as described can be altered by one of ordinary skill in the art as known in the art.

Before further describing one or more embodiments of the present disclosure, it is noted that it will be well understood by a person skilled in the art that a urethane linkage in a polyurethane is formed as the result of a reaction between a diisocyanate monomer, and a polyol monomer. The urethane linkage of the current disclosure can be represented by any of the following structures. It will be well understood, according to the following structures that R and R′, independently, make up the remaining backbone of the polymer made from the diisocyanate and polyol described herein. It will be well understood by a person skilled in the art that in structures described herein R will represent the structural contribution from the diisocyanate monomer, and R′ will represent the structural contribution from the polyol monomer. For example, in the following structure representing a urethan linkage in a polyurethane, R represents the structural contribution from the diisocyanate monomer, and R′ represents the structural contribution from the polyol monomer:

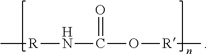

The methods described herein can be applied to both aliphatic and aromatic polyurethanes. Aliphatic polyurethanes described herein can include but are not limited to hexamethylene diisocyanate (HDI) based polyurethanes, isophorone diisocyanate (IPDI) based polyurethanes, or hydrogenated methylene diphenyl diisocyanate (HMDI) based polyurethanes. Aromatic polyurethanes described herein can include but are not limited to methylene diphenyl diisocyanate (MDI) based polyurethanes, or toluene diisocyanate (TDI) based polyurethanes, The methods described herein can be post-polymerization modifications to existing foam. Thereby avoiding radical reactions which can be less specific.

Surprisingly, the methods described herein can be 1 step derivatizations of foam. Thus, these synthetic methodologies for functionalizing the surface of PUF can be extended to areas such as water-wicking foams and filtration media tailored for the selective capture of contaminants.

Aspects of the disclosure are drawn towards surface-modified polyurethane foams (PUF), comprising at least one urethane linkage functionalized with 2-(oxazolidine-3-yl), tetradecyl isocyanate, or a combination thereof.

Before further describing one or more embodiments of the present disclosure, it is noted that it will be well understood by a person skilled in the art that a urethane linkage in a polyurethane is formed as the result of a reaction between a diisocyanate monomer, and a polyol monomer. The urethane linkage of the current disclosure can be represented by any of the following structures. It will be well understood, according to the following structures that R and R′, independently, make up the remaining backbone of the polymer made from the diisocyanate and polyol described herein. It will be well understood by a person skilled in the art that in structures described herein R will represent the structural contribution from the diisocyanate monomer, and R′ will represent the structural contribution from the polyol monomer.

In embodiments, the foam is an “O-modified” PUF comprising at least one urethane linkage-functionalized with 2 (oxazolidine-3-yl). In embodiments the “O-modified” urethane linkage is:

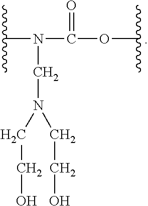 [SMILES: *OC(=O)N(*)CN(CCO)CCO]

In embodiments, the foam is an “IL-modified” PUF comprising at least one urethane linkage functionalized with tetradecyl-isocyanate. In embodiments the “IL-modified” urethane linkage is:

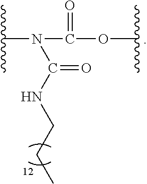

In embodiments, the foam is an “ILO-modified PUF comprising at least one urethane linkage functionalized with a combination of 2 (oxazolidine-3-yl) and tetradecyl isocyanate. In embodiments the “ILO-modified” urethane linkage is:

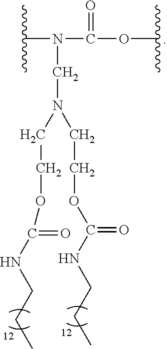

In embodiments, the O-modified PUF is surface responsive. As used herein, the term “surface responsive” can refer to the ability to switch surface energies depending on the environment. For example, and as shown in the water/oil uptake results described herein, the polar hydroxyl groups can form hydrogen bonds in polar solvent while ring closing and self-bonding in the presence of non-polar solvent. In a non-polar solvent, the hydroxyl groups of the O-modified PUF can participate in intramolecular hydrogen bonding, thereby decreasing the hydrophilic properties of the foam.

In embodiments, the surface responsive foam can be used in slow-release applications. For example, the modified PUF's polarity can be tailored to accommodate active agents and reagents that are not soluble in the polyurethane matrix. The slow-release applications can comprise controlled release of active agents. For example, the active agents can be a low mass molecule such as a pharmaceutical or an anti-bacterial agent. In embodiments, the controlled release can have sustained performance. In embodiments, the rate of release can be controlled by the porosity of the modified PUF. For example, see Qiao et al., Fuel, 2021, doi.org/10.1016/j.fuel.2021.121219 and Yang et al., Geoenergy Science and Engineering, 2024, doi.org/10.1016/j.geoen.2023.212582. By modulating the porosity, the effective surface area of the foam can be functionalized through methods described herein.

In embodiments, the surface-responsive foams can have reversible surfaces that can change in properties in contacts with different environments. For example, as such, the O-modified PUF described herein can demonstrate hydrophobic character or hydrophilic character depending on the environment it is exposed to. In an aqueous environment, surface modifier groups can form hydrogen bonds with water molecules thus increasing hydrophilicity. However, the same O-modified PUF, as described herein, can form intramolecular hydrogen bonds in non-polar environments decreasing hydrophilicity. Therefore, in some embodiments, the foams can selectively absorb or release specific agents depending on the environment. In embodiments, the modified PUF can have reversible adhesion properties through exposure to a solvent or water. In embodiments, the PUF can be used in the selective capture of impurities based upon tailored affinity of compounds to the PUF surface. Releasing captured impurities from entrapment can then be achieved by changing the surrounding environment. In embodiments, these foams can be used in both humid or wet environments as well as oil environments. For example, these foams are functional depending on the humidity or water level.

In embodiments, the foam functionalized with 2 (oxazolidine-3-yl) is

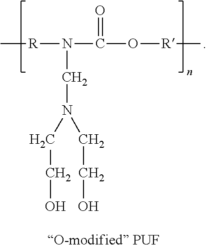

In embodiments, the foam functionalized with tetradecyl isocyanate is

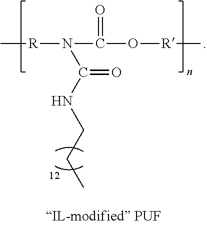

In embodiments, the foam functionalized with a combination of 2 (oxazolidine-3-yl) and tetradecyl isocyanate is

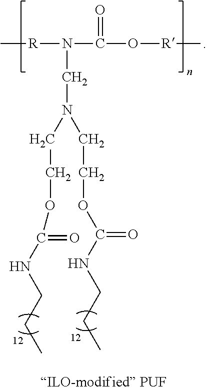

In some embodiments, the O-modified PUF can be further modified through silylation of the pendant hydroxyl groups on the O-modifier. For example, pentamethylchlorodisilane can be added to the O-modifier group on the PUF described herein.

In one or more of the embodiments of the present disclosure, the degree of modification of the PUF refers to the percentage of total urethane linkages that have been modified by any one of the modifiers described in this disclosure. The modifiers described herein can include the O-modifier, the IL-modifier, or the ILO-modifier. Not wishing to be bound, the degree of modification can be tuned and/or tailored based on the application. The degree of modification, under some embodiments, can be tuned and/or tailored based on the reaction conditions. For example, the reaction conditions that can control the degree of modification can be temperature, time, or concentration of reagents.

The modified PUF, as described in this disclosure, can have a degree of modification that ranges from about 1% of the urethane linkages to 100% of the urethane linkages. In some embodiments, the degree of modification can be from about 1% of the urethane linkages to about 20% of the urethane linkages. The degree of modification can be from about 20% of the urethane linkages to about 40% of the urethane linkages. The degree of modification can be from about 40% of the urethane linkages to about 60% of the urethane linkages. The degree of modification can be from about 60% of the urethane linkages to about 80% of the urethane linkages. The degree of modification can be from about 80% of the urethane linkages to 100% of the urethane linkages.

In some non-limiting exemplary embodiments, the O-modified PUF can have a degree of modification of about 1% to about 100%. For example, the O-modified PUF can have a degree of modification of about 1% to about 20%, under some embodiments. For example, the O-modified PUF can have a degree of modification of about 20% to about 40%, under some embodiments. For example, the O-modified PUF can have a degree of modification of about 40% to about 60%, under some embodiments. For example, the O-modified PUF can have a degree of modification of about 60% to about 80%, under some embodiments. For example, the O-modified PUF can have a degree of modification of about 80% to 100%, under some embodiments.

In some non-limiting exemplary embodiments, the IL-modified PUF can have a degree of modification of about 1% to about 100%. For example, the IL-modified PUF can have a degree of modification of about 1% to about 20%, under some embodiments. For example, the IL-modified PUF can a degree of modification of about 20% to about 40%, under some embodiments. For example, the IL-modified PUF can have a degree of modification of about 40% to about 60%, under some embodiments. For example, the IL-modified PUF can have a degree of modification of about 60% to about 80%, under some embodiments. For example, the IL-modified PUF can have a degree of modification of about 80% to 100%, under some embodiments.

In some non-limiting exemplary embodiments, the ILO-modified PUF can have a degree of modification of about 1% to about 100%. For example, the ILO-modified PUF can have a degree of modification of about 1% to about 20%, under some embodiments. For example, the ILO-modified PUF can a degree of modification of about 20% to about 40%, under some embodiments. For example, the ILO-modified PUF can have a degree of modification of about 40% to about 60%, under some embodiments. For example, the ILO-modified PUF can have a degree of modification of about 60% to about 80%, under some embodiments. For example, the ILO-modified PUF can have a degree of modification of about 80% to 100%, under some embodiments.

In embodiments, the polyurethane is a post-consumer polyurethane. As used herein, the term “post-consumer” can refer to a source of material that originates after the end consumer has used the material in a consumer good or product. For example, the post-consumer product can be a mattress, a furniture cushion, a car seat cushion, rigid insulation foam, a sound dampening foam, a packaging material, thermal insulation, safeguarding materials, or a carpet underlay material.

In embodiments, the foam is an open-cell foam, a closed-cell foam, or can comprise a layer of both open-cell and closed cell foams. In some embodiments, the foam performance can be tuned through control of the open-cell or closed-cell characteristics. For example, mechanical and thermal expansion or solvent swelling can be used to introduce open-cell characteristics.

In embodiments, the polyurethane is an aliphatic polyurethane, an aromatic polyurethane, or comprises both aliphatic and aromatic components.

In embodiments, the O-modified PUF comprises an oil absorption capacity of about 20 g/g to about 60 g/g. The O-modified PUF described herein can comprise an oil absorption capacity of about 20 g/g to about 30 g/g under some embodiments. The O-modified PUF described herein can comprise an oil absorption capacity of about 30 g/g to about 50 g/g under some embodiments. The O-modified PUF described herein can comprise an oil absorption capacity of about 40 g/g to greater than about 75 g/g. For example, the oil absorption capacity of the O-modified PUF described herein can be about 28.1 g/g. For example, the oil adsorption capacity of the O-modified PUF described herein can be about 20 g/g, about 25 g/g, about 30 g/g, about 35 g/g, about 40 g/g, about 45 g/g, about 50 g/g, about 55 g/g, about 60 g/g, about 65 g/g, about 70 g/g, about 75 g/g, or greater than about 75 g/g. In embodiments, the O-modified PUF comprises a water absorption capacity of about 15 g/g to about 40 g/g. The O-modified PUF described herein can comprise a water absorption capacity of about 15 g/g to about 30 g/g under some embodiments. The O-modified PUF described herein can comprise a water absorption capacity of about 20 g/g to about 40 g/g under some embodiments. The O-modified PUF described herein can comprise a water absorption capacity of about 30 g/g to greater than about 50 g/g. For example, the O-modified PUF can comprise a water absorption capacity of about 25.3 g/g. For example, the O-modified PUF can comprise a water absorption capacity of about 15 g/g, about 20 g/g, about 25 g/g, about 30 g/g, about 35 g/g, about 40 g/g, or greater than about 40 g/g.

In embodiments, the IL-modified PUF comprises an oil absorption capacity of about 10 g/g to about 35 g/g. The IL-modified PUF described herein can comprise an oil absorption capacity of about 10 g/g to about 25 g/g under some embodiments. The IL-modified PUF described herein can comprise an oil absorption capacity of about 20 g/g to about 40 g/g. For example, IL-modified PUF described herein comprises an oil absorption capacity of about 21.4 g/g. For example, the IL-modified PUF described herein can comprise an oil absorption capacity of about 10 g/g, about 12 g/g, about 14 g/g, about 16 g/g, about 18 g/g, about 20 g/g, about 22 g/g, about 24 g/g, about 26 g/g, about 28 g/g, about 30 g/g, or greater than about 30 g/g. In embodiments, the IL-modified PUF comprises a water absorption capacity of less than about 0.1 g/g to about 7.5 g/g. The IL-modified PUF described herein can comprise a water absorption capacity of about 1 g/g to about 5 g/g under some embodiments. For example, the IL-modified PUF comprises a water absorption capacity of about 2.7 g/g. For example, the IL-modified PUF comprises a water absorption capacity of less than about 0.1 g/g, about 0.1 g/g, about 0.25 g/g, about 0.5 g/g, about 0.75 g/g, about 1.0 g/g, about 1.5 g/g, about 2.0 g/g, about 2.25 g/g, about 2.5 g/g, about 2.75 g/g, about 3.0 g/g, about 3.5 g/g, about 4.0 g/g, about 4.5 g/g, about 5.0 g/g, about 5.5 g/g, about 6.0 g/g, about 6.5 g/g, about 7.0 g/g, or about 7.5 g/g.

In embodiments, the ILO-modified PUF comprises an oil absorption capacity of about 30 g/g to about 60 g/g. The ILO-modified PUF described herein can comprise an oil absorption capacity of about 40 g/g to about 55 g/g under some embodiments. The ILO-modified PUF described herein can comprise an oil absorption capacity of about 30 g/g to about 50 g/g. For example, the ILO-modified PUF comprises an oil absorption capacity of about 45.1 g/g. For example, the ILO-modified PUF comprises an oil absorption capacity of about 30 g/g, about 32 g/g, about 35 g/g, about 37 g/g, about 40 g/g, about 42 g/g, about 45 g/g, about 47 g/g, about 50 g/g, about 52 g/g, about 55 g/g, about 57 g/g, or about 60 g/g.

In embodiments, the ILO-modified PUF comprises a water absorption capacity of about 10 g/g to about 40 g/g. The ILO-modified PUF described herein can comprise a water absorption capacity of about 15 g/g to about 30 g/g. The ILO-modified PUF described herein can comprise a water absorption capacity of about 10 g/g to about 20 g/g. For example, the ILO-modified PUF comprises a water absorption capacity of about 21.3 g/g, under some embodiments. For example, the ILO-modified PUF comprises a water absorption capacity of about 10 g/g, about 12 g/g, about 14 g/g, about 16 g/g, about 18 g/g, about 20 g/g, about 22 g/g, about 24 g/g, about 26 g/g, about 28 g/g, about 30 g/g, about 32 g/g, about 34 g/g, about 36 g/g, about 38 g/g, or about 40 g/g.

Aspects of the disclosure are drawn towards a method of functionalizing a polyurethane foam, the method comprising submerging the foam in 2-(oxazolidine-3-yl) or tetradecyl isocyanate and heating the submerged foam to about 50° C. to about 90° C. for about 0 hours to about 24 hours.

In embodiments, the foam can be heated to less than about 30° C., about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In embodiments, the foam can be submerged for less than about 0.1 hrs, about 0.1 hrs, about 0.25 hrs, about 0.5 hrs, about 1 hr, about 1.5 hrs, about 2 hrs, about 2.5 hrs, about 3.0 hrs, about 3.5 hrs, about 4.0 hrs, about 4.5 hrs, about 5 hrs, about 6 hrs, about 7 hrs, about 8 hrs, about 9 hrs, about 10 hrs, about 11 hrs, about 12 hrs, about 13 hrs, about 14 hrs, about 15 hrs, about 16 hrs, about 17 hrs, about 18 hrs, about 19 hrs, about 20 hrs, about 21 hrs, about 22 hrs, about 23 hrs, about 24 hrs, about 26 hrs, about 18 hrs, about 30 hrs, about 32 hrs, about 34 hrs, about 36 hrs, about 38 hrs, about 40 hrs, about 42 hrs, about 44 hrs, about 46 hrs, about 48 hrs, or greater than about 48 hrs.

In embodiments, the foam is a post-consumer foam. In embodiments, the polyurethane is an aliphatic polyurethane or an aromatic polyurethane. In embodiments, the foam is submerged in 2-(oxazolidine-3-yl), thereby generating a foam with the following modified urethane/carbamate linkages:

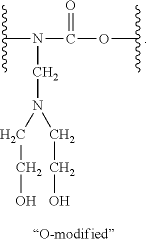 [SMILES: *OC(=O)N(*)CN(CCO)CCO]

In embodiments, the foam is submerged in tetradecyl isocyanate, thereby generating a foam with the following modified urethane/carbamate linkages:

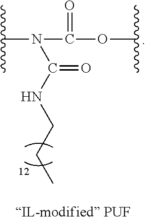

In embodiments, the method can further comprise rinsing and drying the O-modified PUF and submerging the foam in tetradecyl isocyanate thereby generating a foam with the following modified urethane/carbamate linkages:

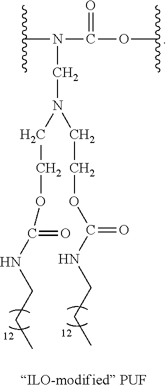

In embodiments, the foam is submerged in 2-(oxazolidine-3-yl), thereby generating:

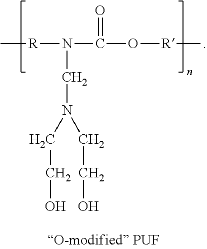

In embodiments, the foam is submerged in tetradecyl isocyanate, thereby generating:

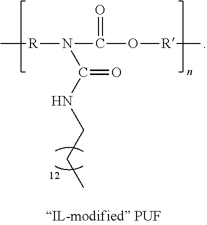

In embodiments, the method can further comprise rinsing and drying the O-modified PUF; and submerging the foam in tetradecyl isocyanate thereby generating:

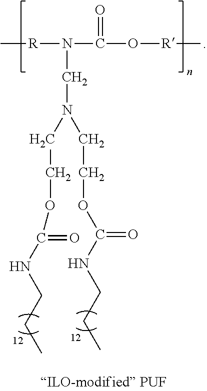

Aspects of the disclosure are drawn towards a method of oil remediation, the method comprising: submerging a surface-modified polyurethane foam (PUF) in a liquid composition comprising an oil, wherein the surface-modified PUF comprises at least one urethan linkage functionalized with 2-(oxazolidine-3-yl), tetradecyl isocyanate, or a combination thereof; and removing the surface-modified PUF, thereby removing the oil from the liquid composition.

In embodiments, the method further comprises compressing or squeezing the foam to release the oil from the foam, thereby reactivating the foam. As used herein, the term “reactivating” can refer to re-functionalizing the foam. In embodiments, the polyurethane foam is a post-consumer polyurethane foam. Therefore, the foams described herein can be reusable.

### EXAMPLES

Examples are provided herein to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Surface Functionalization of Polyurethane Foams for Enhanced Hydrophobicity

Oil contamination in water resources remains a significant concern for human and environmental health, and organic sorbents are among the prominent technologies developed for remediation. Meanwhile, the growing appetite for polyurethane foams (PUF) has produced challenges in the recycling and management of post-consumer PUFs. This study explores a new approach to enhance the oleophilicity of commercial PUFs through surface modification. Introducing new pathways to functionalize commercial PUFs with facile processing routes may simultaneously enable PUF waste management and oil spill remediation. Surface modification with 2-(oxazolidin-3-yl) ethanol and tetradecyl isocyanate on commercial PUFs provides significant enhancements of oil/water uptake with high selectivity, as well as providing thermal and chemical stability. Various characterization methods, including TGA, SEM, and XPS, collectively reveal the chemical and physical properties of surface-functionalized PUFs. This research potentially enables cost-effective and scalable surface modification of PUFs for their application in controlling oil contamination. Surface functionalized PUFs present an opportunity for various applications, including oil spill remediation and oil/water separation processes to tackle water resources contamination.

### INTRODUCTION

For centuries, different human activities have polluted water resources. Marine transportation and industrial waste streams have significantly contributed to oil contamination of clean waters.¹ Exxon Valdez in 1989 (11 million gallons) and Deep Horizon in 2010 (4.9 million barrels) were two of the greatest oil spill disasters that heavily affected the marine environment.^{2, 3} Natural water movement, alongside weather and climate change, increases the oil transportation on the water surface far beyond its original location, harming marine and terrestrial organisms.⁴ Researchers are developing various technologies to control and remediate oil spills, including physical/mechanical, chemical, and biological methods.⁵⁻⁸ Cost efficiency and rapid absorption rates of organic sorbents have made them a suitable recovery method for oil spill scenarios. Polyurethane foams (PUFs) are among the most popular organic sorbents.⁹

Due to their tunable properties for different commercial applications, polyurethanes (PU) have gained popularity in recent decades, and PU-containing products play a crucial role in our daily lives.¹⁰ The global market for PU, primarily available as covalently crosslinked PUFs, is expected to exceed $90.3B in 2032 and currently represents a market share of 23% among foamed polymers.¹¹ The growing demand for microcellular materials and metamaterials in rapidly emerging technologies, ranging from lightweight materials for construction and infrastructure to ubiquitous foam mattresses and energy-saving insulations, continues to contribute to the large volumes of solid waste that must be managed. With over 50,000 mattresses discarded in the U.S. daily that contain more than 75% recyclable components, the low recycling rate of 5-10% diverts the majority of valuable resources to local landfills.¹² A major barrier preventing broader adoption of mattress recycling is economics. While steel and wood are relatively easily recycled, the market for recovered PU foam is limited to one main low-value application-carpet padding (or re-bond). Therefore, there is a need to drive broader recycling and higher recycling rates and develop additional, higher-value markets for recycled PUF.^{13, 14}

Existing studies have demonstrated successful surface oleophilic enhancement of polymeric materials for various applications, such as membranes,¹⁵⁻¹⁷ hydrogels,^{18, 19} aerogels and sponges,^{20, 21} and nanowires and nanotubes.^{22, 23} Surface modifications such as spray coating,²⁴ chemical vapor deposition (CVD),²⁵ grafting,²⁶-29 and hydrothermal processing³⁰ enhance PUF performance. Barry et al. at Argonne National Laboratory utilized sequential infiltration synthesis (SIS) to activate post-consumer foams to create oleophilic products.³¹ Despite exhibiting enhanced oil sorption properties, these early advances lacked facile processing routes. In addition, Ng et al. implemented a CVD method to functionalize PU foam surfaces with hydrophobic monomers. While the aforementioned method deposits ultra-thin layers with versatile chemistry, the complex and high-cost equipment, slow deposition rates, and size limitations hindered potential commercial impact.²⁵

Herein, this research proposes a new route toward PUF surface functionalization utilizing reactive groups in existing carbamate linkages within the foam matrix. This synthetic method may present a cost-effective and scalable approach with facile processing, leveraging commercially available PUF. 2-(oxazolidin-3-yl) ethanol and tetradecyl isocyanate were used to functionalize the PUF surface. The modified PUFs were investigated for absorption capacities, e.g., for oil absorption processes. The foam surface functionalization and oleophilicity/hydrophilicity were characterized using x-ray photoelectron spectroscopy (XPS), thermogravimetric analysis (TGA), scanning electron microscopy (SEM), and a series of oil/water absorption tests.

### Experimental

### Materials

PUF was supplied by Covestro AG. Tetradecyl isocyanate, tert-butyldimethylsilyl chloride, chloroform-d (CDCl₃, 99.8%), diethanolamine (DEA), and paraformaldehyde were obtained from Sigma-Aldrich and used as received.

### Synthesis of 2-(oxazolidin-3-yl) ethanol

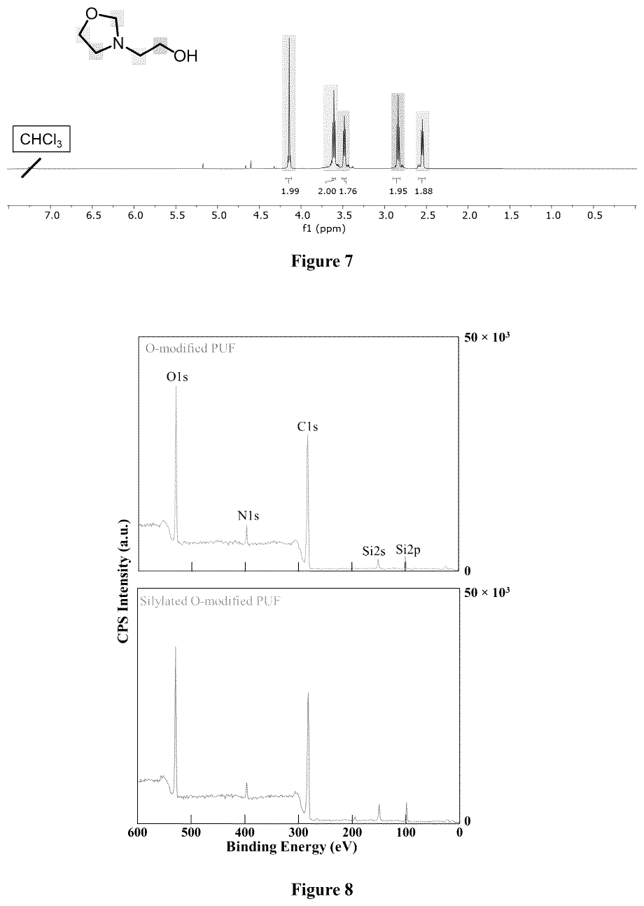

The reaction was performed as described in the literature (Scheme 2).³² A solution of diethanolamine (105 g, 1.00 mol) in isopropanol (200 ml) was added to a suspension of paraformaldehyde (30.0 g, 1.00 mol) in toluene (200 mL). The mixture was heated to 80° C. under reflux for 18 h. The solvents were removed under reduced pressure for 12 h to yield the product 2-(oxazolidin-3-yl) ethanol (89.2 g, 85.0%). The final chemical structure was verified with 1H NMR spectroscopy in CDCl₃ as shown in FIG. 7.

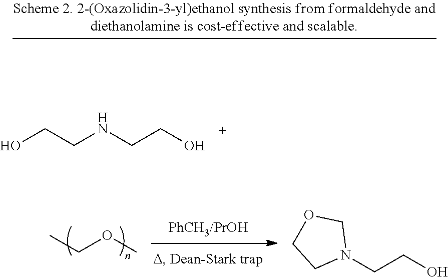

### Surface Functionalization of PUF

Each PU foam was cut into 1 cm cubes. PU foam pieces were washed with methanol and dried in an oven under reduced pressure at 60° C. for 12 h. The following process was used for surface modification; each PUF piece was submerged in 3.0 mL of modifying agent to ensure complete exposure; detailed reaction conditions are illustrated in the supporting information Schemes 3-5. 2-(Oxazolidin-3-yl) ethanol, tetradecyl isocyanate, and a combination of both were utilized to modify the surface of PUFs.

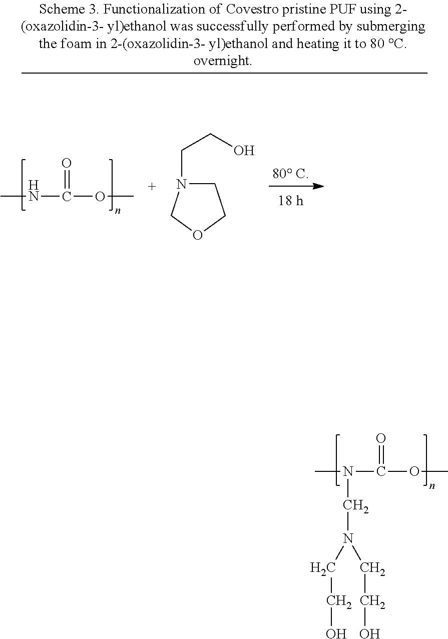

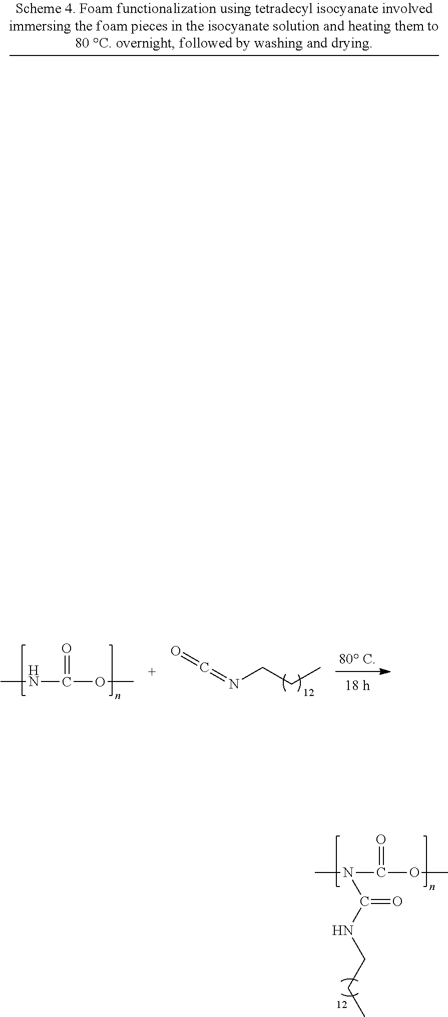

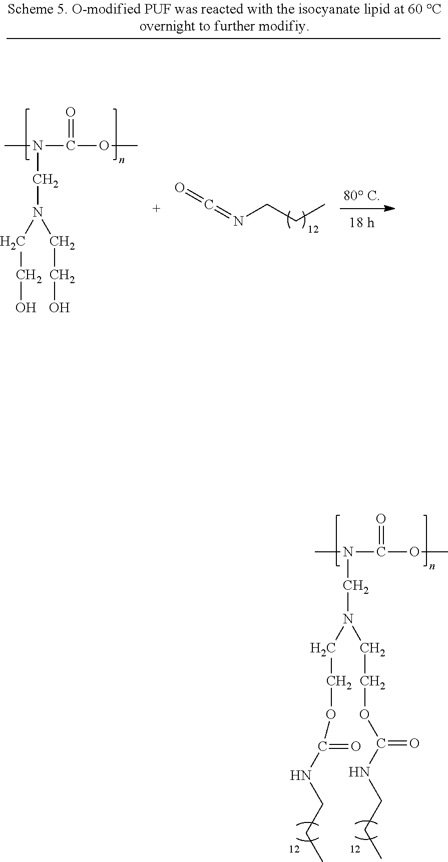

As shown in Scheme 1, surface-modified PUFs are referred to as O-modified, IL-modified, and ILO-modified PUFs, respectively. Ultimately, surface-modified PUF pieces were washed with methanol and dried under reduced pressure at 90° C. for 12 h.

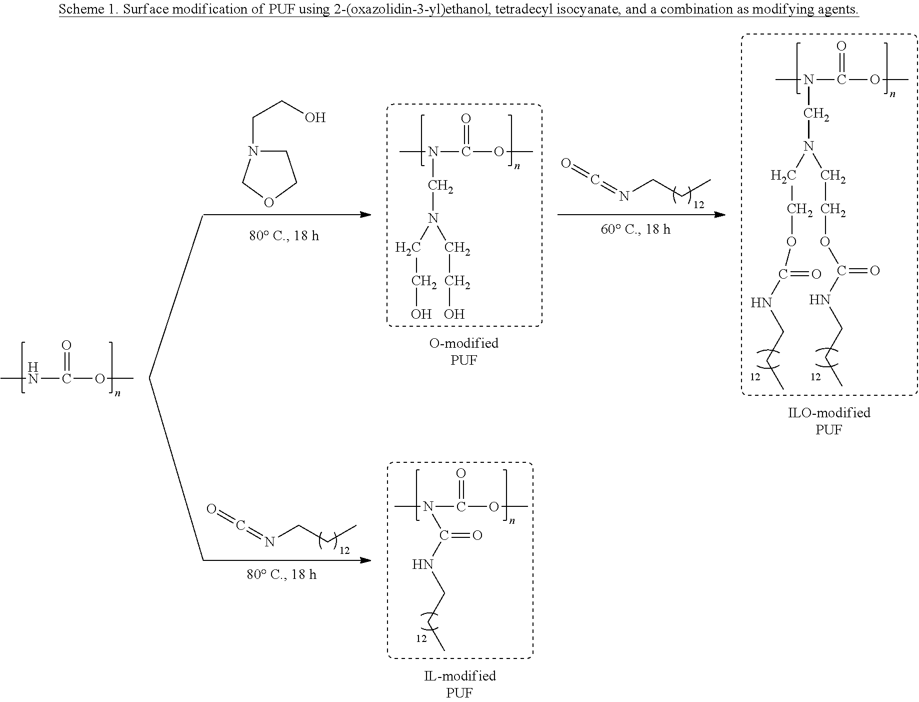

### Characterization

Prior to analysis, all samples were dried in an oven for 16 h at 90° C. Scanning electron microscopy (SEM) was performed on a Thermoscientific Phenom XL G2 desktop SEM under backscattering detector, 0.1 Pa vacuum, and 10 KV accelerating voltage. Thermogravimetric analysis (TGA) was performed using a TA Instruments TGA 5500 under N₂ at a heating rate of 10° C./min. X-ray photoelectron spectroscopy (XPS) was conducted on Kratos Axis Supra+ with survey mode. A thin layer of finely cut PUF was adhered to glass slides for XPS measurements.

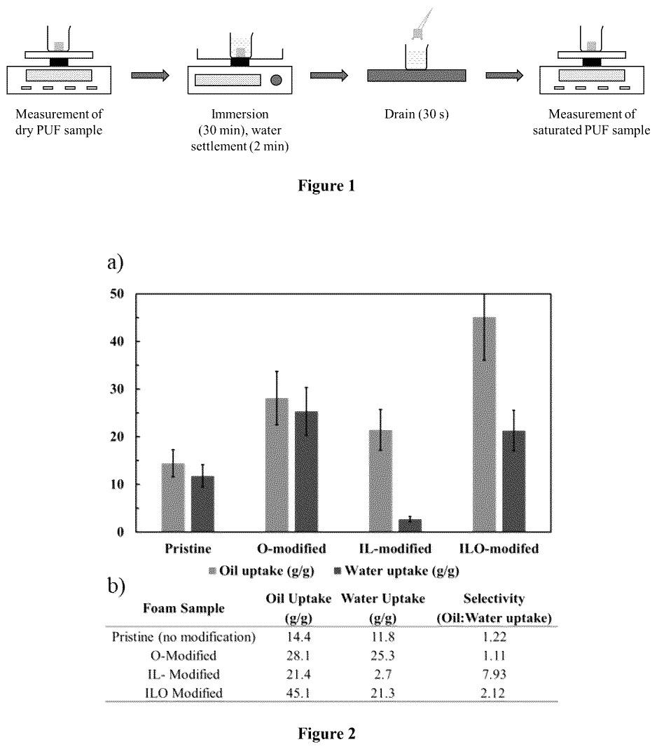

The method to measure the oil/water absorption capacity of PUF samples is illustrated in FIG. 1. 100 mL of pure mineral oil and pure water were separately poured into glass jars. The initial dry weight of PUF samples was measured and recorded. Dry PUF samples were immersed in liquid-containing jars. Subsequently, the jars were placed on a shaker table at 150 rpm for 30 min. After 30 min, the samples were removed from the shaker table and allowed to settle for 2 min. Following this step, the samples were removed and held for 30 s to drain off the excess liquid. The PUF samples' saturated weight was measured and recorded. The following equation calculates oil/water uptake:

$$oil / water uptake ( g / g ) = ( {S}_{f} - {S}_{i} ) / {S}_{i} \qquad ( 1 )$$

where Sᵢ is the initial dry weight of the PUF sample and Sf is the final saturated weight.

### Non-Limiting Results and Discussion

Oil and water uptake of the pristine and surface-modified PUF cubes were measured as described above. The results, illustrated in FIG. 2, revealed a significant change in the oleophilic/hydrophilic properties, depending on the modification type.

The unmodified pristine PUF exhibited an oil uptake of 14.4 g/g and a water uptake of 11.8 g/g. O-modified PUF demonstrated a notable increase in both oil and water uptake, reaching 28.1 g/g for oil, and 25.3 g/g for water, reflecting improved overall sorption properties. Hydroxyl groups form hydrogen bonds with water molecules, encouraging higher hydrophilicity in an aqueous environment, which, without wishing to be bound by theory, contributes to the higher water absorption. In a non-polar environment, the two hydroxyl groups of the O-modified PUF, without wishing to be bound by theory, participate in intramolecular hydrogen bonding, decreasing the hydrophilic properties of the foam. This, along with the more open-celled nature of the O-modified foam (see below), can explain the increase in oil absorption observed.

IL-modified PUF displayed superior performance with an oil uptake of 21.4 g/g and a markedly reduced water uptake of 2.7 g/g. As summarized in FIG. 2, this modification achieved an oil: water selectivity of 7.92, representing an approximately 7-fold improvement compared to the unmodified foam or O-modified PUF. This finding aligns with the expected enhancement in oleophilicity and reduction in hydrophilicity resulting from the hydrophobic, non-polar long-chain alkyl isocyanate attached to the foam surface.

The ILO modified foam showed a marked additional increase in oil absorption (45.1 g/g) and a small decrease in water absorption (21.3 g/g) compared to the O-modified foam. This is consistent with an increase in oleophilicity resulting from reaction of the hydroxyl groups of the O-modified foam with the very oleophilic long chain aliphatic isocyanate.

The surface-modified PUFs exhibited oil uptakes ranging from 21 to 45 g/g, significantly higher than reported for two different polypropylene-based commercial oil-absorbing products, which show oil uptake values of ~8 to 12 g/g.^{33, 34}

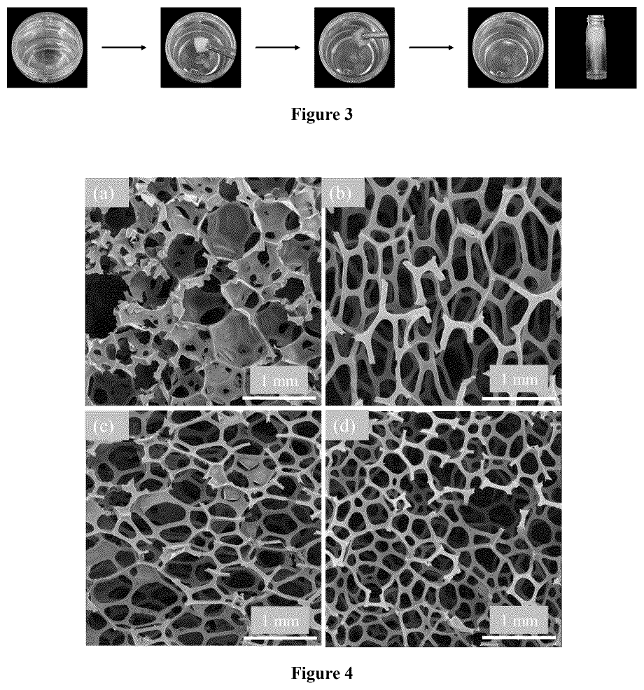

As illustrated in FIG. 3, the IL-modified PUF effectively absorbed mineral oil floating on the surface of water, leaving no visible separate layer of mineral oil after collection. Furthermore, the liquid retrieved from the IL-modified PUF, as depicted in FIG. 3, did not show evidence of major layer separation, indicating high selectivity of the modified PUF for oil absorption.

The modified surface functionalities of the PUF samples significantly impacted their oil and water uptake capacities, but we also carried out analysis of the surface to collect further evidence for the chemical modification of the surface. Scanning electron microscopy (SEM) imaging, presented in FIGS. 4A-4D, highlighted structural changes in the foam surfaces following modification. FIG. 4A illustrates the pristine PUF's three-dimensional porous structure. In contrast, post-modification SEM images revealed a more open-cell structure compared to the smooth surface of the unmodified sample. Additionally, SEM images of the modified PUF samples, shown in FIG. 4B-4D, displayed more irregular three-dimensional structures on their surfaces. Notably, the modification using 2-(oxazolidin-3-yl) ethanol caused a more significant impact on the foam's cellular structure compared to the isocyanate lipid modification route.

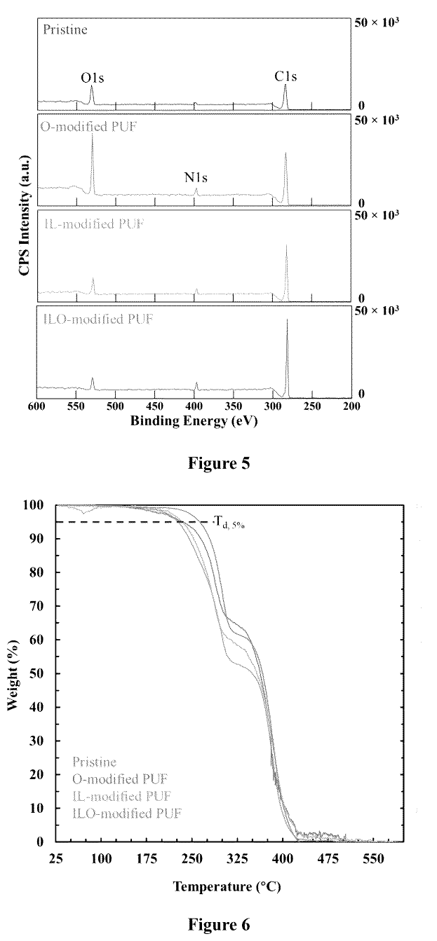

XPS analysis provided a detailed method for investigating the surface composition of PUF samples. The XPS survey scans of the PUF samples, before and after surface modification, as shown in FIG. 5, demonstrated significant changes in the 01s signal at ~530 eV, the C₁s signal at ~285 eV, and the N1s signal at ~395 eV, corresponding to the introduction of surface functionalities absent in the pristine PUF samples. Carbon, nitrogen, and oxygen atoms were measured on the surface of the PUF both before and after modification, and atom concentration % is summarized in Table 1. After the surface modification with 2-(oxazolidin-3-yl) ethanol, an increase in oxygen content to (18.50%) and carbon content to (73.32%) indicated the addition of these groups to the surface of the foam. Further analysis of IL-modified PUFs revealed a significant increase in carbon content (82.61%) and a decrease in oxygen (8.83%). PUFs modified with both 2-(oxazolidin-3-yl) ethanol and isocyanate lipids demonstrated a further increase in carbon (88.06%) and nitrogen (4.68%) concentrations while reducing oxygen content to (6.14%). This elemental composition aligned with the expected addition of non-polar lipid groups to the already modified foam surface, resulting in enhanced oleophilicity compared to 2-(oxazolidin-3-yl) ethanol-only modification.

TABLE 1
Elemental atom concentration % of pristine and surface-modified PUFs.
Atom concentration %

| PUF sample | C | N | O | O/C | N/C | N/O |
|---|---|---|---|---|---|---|
| Pristine | 72.38 | 2.51 | 16.03 | 0.22 | 0.03 | 0.16 |
| O-modified | 73.32 | 2.44 | 18.50 | 0.25 | 0.03 | 0.13 |
| IL-modified | 82.61 | 4.21 | 8.83 | 0.11 | 0.05 | 0.48 |
| ILO-modified | 88.06 | 4.68 | 6.14 | 0.07 | 0.05 | 0.76 |

The IL-modified PUF, which demonstrated the highest oil selectivity, exhibited N/C and N/O ratios of 0.05 and 0.48, respectively, indicating a significant increase in carbon content, resulting in a more hydrophobic surface structure. This analysis was consistent with the ILO-modified PUFs, which showed the highest oil absorption capacity. In contrast, the O-modified PUF presented an O/C ratio of 0.25 and an N/C ratio of 0.03. Compared to the pristine PUF, these values reflected a higher oxygen content on the foam's surface, aligning with the anticipated presence of the 2-(oxazolidin-3-yl) ethanol modifying group.

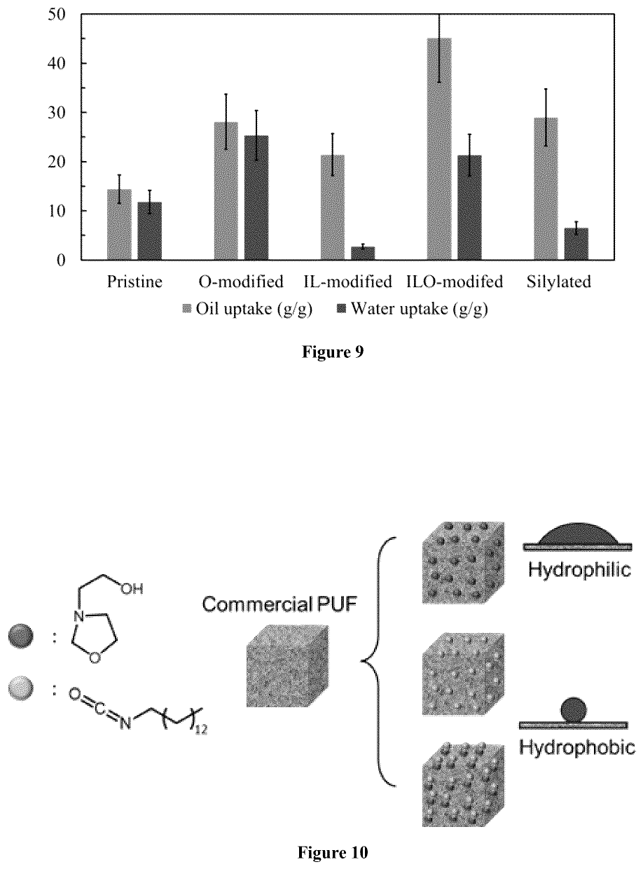

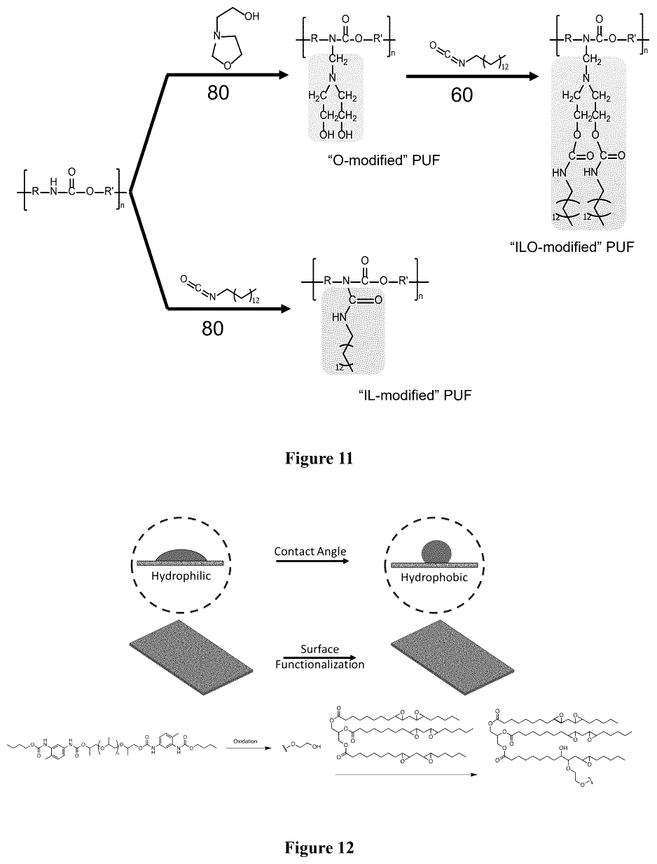

To further investigate the surface properties and confirm the presence of expected functional groups (i.e., hydroxyl groups introduced through modification with 2-(oxazolidin-3-yl) ethanol), silylation of O-modified PUFs was conducted (Scheme 6). XPS analysis verified the successful silylation of the O-modified PUFs. The Si content on the PUF surface increased from 5.75% to 8.10% following silylation, confirming the addition of silyl groups (FIG. 8). The ratio of added silicon to nitrogen (Si/N~2) indicated that the surface effectively reacted during the silylation process. Furthermore, the introduction of non-polar groups reduced the hydrophilicity of the PUF samples, as demonstrated by the results of oil/water absorption tests (FIG. 9).

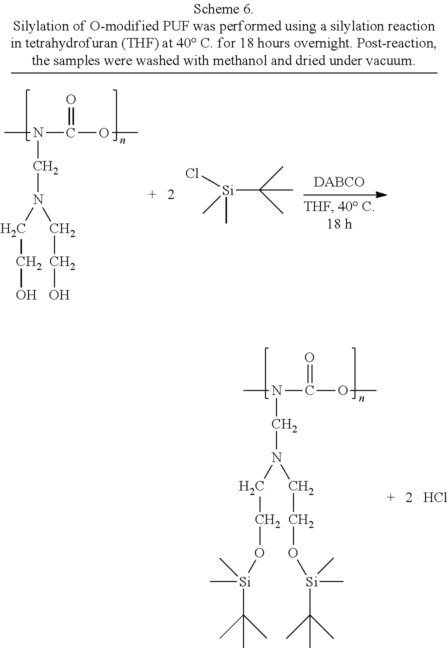

In addition to the high selectivity of IL-modified PUF, the increase in both oleophilicity and hydrophilicity observed in O-modified PUFs is noteworthy. The discussed results herein indicated that hydroxyl groups on the surface of O-modified PUF formed intramolecular hydrogen bonds, which provided a shielding effect on the foam in the presence of oil. However, in the presence of water, the hydroxyl groups preferentially formed hydrogen bonds with water, rendering the surface more hydrophilic.³⁵ Based on SEM images of surface-modified PUFs, the O-modified samples exhibited rougher surfaces and higher surface area compared to the pristine foam. According to Wenzel, surface roughness significantly influences wettability, which explains the concurrent increase in oil and water uptake observed alongside the chemical modifications.³⁶ These findings indicate that the proposed surface modification routes substantially impacted the hydrophilicity and oleophilicity of PUFs by altering the cellular structures and surface area of the foam while preserving overall structural integrity. Moreover, the increased surface area plays a partial role in increasing the liquid uptake of the O-modified PUFs, enabling the foam surface to encounter more liquid.

Finally, TGA as depicted in FIG. 6 revealed that the degradation of pristine PUF occurred in two distinct steps. In contrast, the PUFs exhibited three separate weight-loss steps after surface modification. The initial weight loss of the modified foams resulted in a mass loss of approximately 2 wt. %. The second weight loss step, occurring at approximately 275-300° C., corresponded to the degradation of the (—CO—NH—) hard segment. The final weight loss, which was observed at approximately 375-400° C., was attributed to the combined degradation of both hard and soft segments.³⁷ Furthermore, TGA analysis indicated an earlier onset of surface functionality degradation compared to the decomposition steps of the hard and soft segments of the PUF.

### NON-LIMITING CONCLUSIONS

Described herein is a facile approach to surface modification of PUFs. One of the many issues with existing modification methods is the extensive and complicated processing of PUFs for various applications. Post-consumer applications for PUFs have gained attraction due to the growing production and low recycling rates. However, high cost, complex methodology, and scalability have hindered the current recycling methods. This work reports a facile, cost-effective alternative to expand the scope of post-consumer PUF applications to answer prevalent environmental problems.

Surface-modified PUFs indicated enhanced oil/water absorbency factors using the described procedures to attach different modifying groups. Oil/water uptake results indicated the tailored surface functionality of the modified PUFs provided excellent control over oil and water uptake enhancements with high selectivity. TGA and XPS highlighted the successful surface modification of commercial PUFs with alterations from the pristine PUF, while SEM imaging provided insight into the structural alterations of the samples. IL-modified PUF exhibited the highest absorption selectivity, while ILO-modified PUF showed the highest oil uptake.

Various chemical and physical characterization techniques collectively illustrate a pathway to tune the surface properties of PUFs for specific applications. Thus, these synthetic methodologies for functionalizing the surface of PUF can be extended to areas such as water-wicking foams and filtration media tailored for the selective capture of contaminants. This research provides compositions, methods, and pathways to address the need for alternative uses for PUF at the end of its lifetime to reduce its diversion to landfills. Ultimately, the resulting upcycled materials indicate a strategy for sustainability and circularity of polyurethane foams.

### REFERENCES

(1) Doshi, B.; Sillanpaa, M.; Kalliola, S. A review of bio-based materials for oil spill treatment. Water Res 2018, 135, 262-277. DOI: 10.1016/j.watres.2018.02.034. From NLM Medline.
(2) Carson, R. T.; Mitchell, R. C.; Hanemann, M.; Kopp, R. J.; Presser, S.; Ruud, P. A. Environmental and Resource Economics 2003, 25 (3), 257-286. DOI: 10.1023/a: 1024486702104.
(3) Brody, T. M.; Di Bianca, P.; Krysa, J. Analysis of inland crude oil spill threats, vulnerabilities, and emergency response in the midwest United States. Risk Anal 2012, 32 (10), 1741-1749. DOI: 10.1111/j.1539-6924.2012.01813.x. From NLM PubMed-not-MEDLINE.
(4) Barron, M. G. Ecological impacts of the deepwater horizon oil spill: implications for immunotoxicity. Toxicol Pathol 2012, 40 (2), 315-320. DOI: 10.1177/0192623311428474. From NLM Medline.
(5) Dave. Remediation Technologies for Marine Oil Spills: A Critical Review and Comparative Analysis. American Journal of Environmental Sciences 2011, 7 (5), 423-440. DOI: 10.3844/ajessp.2011.423.440.
(6) Teas, C.; Kalligeros, S.; Zanikos, F.; Stournas, S.; Lois, E.; Anastopoulos, G. Investigation of the effectiveness of absorbent materials in oil spills clean up. Desalination 2001, 140 (3), 259-264. DOI: 10.1016/s0011-9164 (01) 00375-7.
(7) Chang, S. E.; Stone, J.; Demes, K.; Piscitelli, M. Consequences of oil spills: a review and framework for informing planning. Ecology and Society 2014, 19 (2). DOI: 10.5751/es-06406-190226.
(8) Azubuike, C. C.; Chikere, C. B.; Okpokwasili, G. C. Bioremediation techniques-classification based on site of application: principles, advantages, limitations and prospects. World J Microbiol Biotechnol 2016, 32 (11), 180. DOI: 10.1007/s11274-016-2137-x. From NLM Medline.
(9) Shimizu, T.; Koshiro, S.; Yamada, Y.; Tada, K. Effect of cell structure on oil absorption of highly oil absorptive polyurethane foam for on-site use. Journal of Applied Polymer Science 1997, 65 (1), 179-186. DOI: 10.1002/(sici) 1097-4628 (19970705)65:1<179::Aid-app21>3.0.Co;2-y.
(10) Sane, D.; Gadekar, A.; Jamdar, V.; Sabnis, A. Recycling of Polyurethanes. In Polyurethanes: Preparation, Properties, and Applications Volume 1: Fundamentals, ACS Symposium Series, Vol. 1452; American Chemical Society, 2023; pp 161-179.
(11) Foam Plastics Market Size, Share & Growth Forecast-2032. https://www.gminsights.com/industry-analysis/foam-plastics-market.
(12) Why Recycle. https://mattressrecyclingcouncil.org/why-recycle/.
(13) Zia, K. M.; Bhatti, H. N.; Ahmad Bhatti, I. Methods for polyurethane and polyurethane composites, recycling and recovery: A review. Reactive and Functional Polymers 2007, 67 (8), 675-692. DOI: https://doi.org/10.1016/j.reactfunctpolym.2007.05.004.
(14) Rossignolo, G.; Malucelli, G.; Lorenzetti, A. Recycling of polyurethanes: where we are and where we are going. Green Chem. 2024, 26 (3), 1132-1152, 10.1039/D3GC02091F. DOI: 10.1039/D3GC02091F.
(15) Kota, A. K.; Kwon, G.; Choi, W.; Mabry, J. M.; Tuteja, A. Hygro-responsive membranes for effective oil-water separation. Nat Commun 2012, 3 (1), 1025. DOI: 10.1038/ncomms2027. From DOI.org (Crossref).
(16) Zhang, Y.; Zhang, X.; Xu, Y.; Li, Y.; Chen, X.; Zeng, Y. Cellulose acetate-based composite fibrous membrane with asymmetric wettability for directional water transport and high-flux oil-water separation. Cellulose 2024, 31 (4), 2493-2502. DOI: 10.1007/s10570-024-05766-3. From DOI.org (Crossref).
(17) Wang, Y.; Yang, S.; Zhang, J.; Chen, Z.; Zhu, B.; Li, J.; Liang, S.; Bai, Y.; Xu, J.; Rao, D.; et al. Scalable and switchable CO2-responsive membranes with high wettability for separation of various oil/water systems. Nat Commun 2023, 14 (1), 1108. DOI: 10.1038/s41467-023-36685-9. From DOI.org (Crossref).
(18) Xue, Z.; Wang, S.; Lin, L.; Chen, L.; Liu, M.; Feng, L.; Jiang, L. A Novel Superhydrophilic and Underwater Superoleophobic Hydrogel-Coated Mesh for Oil/Water Separation. Advanced Materials 2011, 23 (37), 4270-4273. DOI: 10.1002/adma.201102616. From DOI.org (Crossref).
(19) Brito Dos Santos, F.; Perez, I. D.; McMichael, P. S.; Vasconcelos Fregolente, L.; Maciel, M. R. W.; Tam, K. C. Synthesis of a Novel Cellulose Nanofiber-Based Composite Hydrogel with Poly(methyl methacrylate-<i>co</i>-methacrylic Acid) for Effective Water Removal from Liquid Fuels. Ind. Eng. Chem. Res. 2024, 63 (5), 2210-2222. DOI: 10.1021/acs.iecr.3c02019. From DOI.org (Crossref).
(20) Vijay, R.; Balamurugan, T.; Sundaraselvan, S.; Kaviarasu, C.; Sathishkumar, G. B. Investigation on spilled oil absorption ability of graphene oxide coated melamine sponge. Materials Today: Proceedings 2024, 98, 81-85. DOI: 10.1016/j.matpr.2023.09.136. From DOI.org (Crossref).
(21) Ke, W.; Ge, F.; Shi, X.; Zhang, Y.; Wu, T.; Zhu, X.; Cheng, Y.; Shi, Y.; Wang, Z.; Yuan, L.; et al. Superelastic and superflexible cellulose aerogels for thermal insulation and oil/water separation. International Journal of Biological Macromolecules 2024, 260, 129245. DOI: 10.1016/j.ijbiomac.2024.129245. From DOI.org (Crossref).
(22) Liu, S.; Wang, Y.; Tang, X.; Xu, Z.; Peng, C. Fabrication of Polydimethylsiloxane Superhydrophobic Coatings with Self-healing Properties Using the Template Method. J. of Materi Eng and Perform 2024, 33 (3), 1349-1357. DOI: 10.1007/s11665-023-08074-2. From DOI.org (Crossref).
(23) Liu, J.-W.; Liang, H.-W.; Yu, S.-H. Macroscopic-Scale Assembled Nanowire Thin Films and Their Functionalities. Chem. Rev. 2012, 112 (8), 4770-4799. DOI: 10.1021/cr200347w. From DOI.org (Crossref).
(24) Barroso-Solares, S.; Pinto, J.; Fragouli, D.; Athanassiou, A. Facile Oil Removal from Water-in-Oil Stable Emulsions Using PU Foams. Materials 2018, 11 (12), 2382. DOI: 10.3390/ma11122382. From DOI.org (Crossref).
(25) Ng, Z. C.; Roslan, R. A.; Lau, W. J.; Gürsoy, M.; Karaman, M.; Jullok, N.; Ismail, A. F. A Green Approach to Modify Surface Properties of Polyurethane Foam for Enhanced Oil Absorption. Polymers 2020, 12 (9), 1883. DOI: 10.3390/polym12091883. From www.mdpi.com.
(26) Li, X.; Lin, B.; Zheng, C.; Li, Z.; Wang, P.; Liu, G. Superoleophilic polyurethane sponge for highly efficient oil/water separation. mat express 2020, 10 (7), 1122-1126. DOI: 10.1166/mex.2020.1729. From DOI.org (Crossref).
(27) Li, H.; Liu, L.; Yang, F. Oleophilic Polyurethane Foams for Oil Spill Cleanup. Procedia Environmental Sciences 2013, 18, 528-533. DOI: 10.1016/j.proenv.2013.04.071. From DOI.org (Crossref).
(28) A. Tanobe, V. O.; Sydenstricker, T. H. D.; Amico, S. C.; Vargas, J. V. C.; Zawadzki, S. F. Evaluation of flexible postconsumed polyurethane foams modified by polystyrene grafting as sorbent material for oil spills. Journal of Applied Polymer Science 2009, 111 (4), 1842-1849. DOI: 10.1002/app.29180. From DOI.org (Crossref).
(29) Rocha, K. R. D.; Chiavone-Filho, O.; Oliveira, H. N. M. D. Post-Consumer Polyurethane Foams Hydrophobization Through Surface Modifications for Oil Spill Sorption. Mat. Res. 2023, 26 (suppl 1), e20220536. DOI: 10.1590/1980-5373-mr-2022-0536. From DOI.org (Crossref).
(30) Periasamy, A. P.; Wu, W.-P.; Ravindranath, R.; Roy, P.; Lin, G.-L.; Chang, H.-T. Polymer/reduced graphene oxide functionalized sponges as superabsorbents for oil removal and recovery. Marine Pollution Bulletin 2017, 114 (2), 888-895. DOI: 10.1016/j.marpolbul.2016.11.005. From ScienceDirect.
(31) Barry, E.; Mane, A. U.; Libera, J. A.; Elam, J. W.; Darling, S. B. Advanced oil sorbents using sequential infiltration synthesis. J. Mater. Chem. A 2017, 5 (6), 2929-2935. DOI: 10.1039/C6TA09014A. From DOI.org (Crossref).
(32) Fenton, D. E.; Papageorgiou, G. Synthesis of unsymmetrical dinucleating ligands bearing nitrogen and oxygen donor atoms. Tetrahedron 1996, 52 (16), 5913-5928. DOI: 10.1016/0040-4020 (96) 00222-0.
(33) New Pig Oil-Only Absorbent Boom. https://www.newpig.com/pig-oil-only-absorbent-boom/p/BOM405 #detailsBlock.
(34) Brady SPC BattleMat Absorbent. https://www.bradyid.com/tdsdetails?id=SPC-1.
(35) Liu, Y.; Liu, J.; Wang, Z.; Yuan, Y.; Hua, J.; Liu, K. Robust and durable superhydrophobic and oil-absorbent silica particles with ultrahigh separation efficiency and recyclability. Microporous and Mesoporous Materials 2022, 335. DOI: 10.1016/j.micromeso.2022.111772.
(36) Wenzel, R. N. Resistance of solid surfaces to wetting by water. Industrial & engineering chemistry 1936, 28, 988-994.
(37) Chattopadhyay, D. K.; Webster, D. C. Thermal stability and flame retardancy of polyurethanes. Progress in Polymer Science 2009, 34 (10), 1068-1133. DOI: https://doi.org/10.1016/j.progpolymsci.2009.06.002.

### Example 2

### Background

In the global market, polyurethanes (PU) are seeing a surge in popularity, particularly in the form of covalently crosslinked microcellular foams, known as polyurethane foams (PUF). These PUF materials can have applications in various crucial sectors such as construction, infrastructure, foam mattresses, and insulation. However, the growing demand for microcellular materials is contributing to a national crisis as PU foam waste continues to accumulate. Foam functionalization methods are intricate and often involve in-situ functionalization with foaming, which is not suitable for post-consumer PU foam waste.

In this regard, we proposed a new route toward foam functionalization that utilized isocyanate chemistry and reactive N—H groups in existing carbamate linkages within the foam matrix. The methods described herein are surprising improvements over our efforts to react the soft segment of commercial PU foams containing polyether segments by oxidizing and reacting with nature-derived oils, such as soybean or castor oil, to increase oleophilicity (FIG. 12).

### Non-Limiting, Exemplary Embodiments of the Instant Application

Described herein are surface modified polyurethanes for oil remediation. Oil contamination in water resources remains a significant concern for human and environmental health, and organic sorbents are among the prominent technologies developed for remediation. Meanwhile, the growing appetite for polyurethane foams (PUF) has produced challenges in the recycling and management of post-consumer PUFs. Disclosed is a route toward PUF surface functionalization utilizing reactive groups in existing carbamate linkages within the foam matrix. The foam surfaces were functionalized with 2-(oxazolidin-3-yl) ethanol or tetradecyl isocyanate or a combination of both that showed enhanced oil absorption properties compared to non-functionalized PUF. The disclosed methods demonstrate a cost-effective and scalable approach with facile processing, to surface modification of commercially available recycled PU foams.

Non-limiting features described herein: Waste polyurethane foams are surface modified to enhance hydrophobicity. In an embodiment, modified foam shows a significant increase in oil adsorption compared to non-modified foam. The process disclosed herein can be done in bulk, accompanied by an easy cleaning process. The foam was able to hold its shape under an embodiment. Properties were higher than commercially available products available on the market

Non-limiting advantages of the methods described herein over methods in the art include additional pathways to increase mattress recycling rates without complex equipment and high costs; a process amenable to mild heating, cost-effective reagents, and facile purification with high yields; enabling high deposition rates without the size limitations of current approaches; preserving PUF structure with reusability and stable performance; and higher oil uptake than currently available commercial products in the market.

### REFERENCES CITED HEREIN

1. Barry et al., Environmental Science: Water Research & Technology, 2017.
2. Barry et al., Journal of Materials Chemistry A, 2017.
3. Ng et al., Polymers, 2020.
4. Li et al., Materials Express, 2020.
5. Li et al., Procedia Environmental Sciences, 2013.
6. Tanobe et al., J. Appl. Polym. Sci., 2008.
7. Rosendo da Rocha et al., Mat. Res., 2023.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed:

1. A modified polyurethane foam (PUF) comprising at least one urethane linkage functionalized with 2-(oxazolidine-3-yl), tetradecyl isocyanate, or a combination of 2-(oxazolidine-3-yl) and tetradecyl isocyanate.

2. The foam of claim 1, wherein the foam is an “O-modified” PUF comprising at least one urethane linkage functionalized with 2 (oxazolidine-3-yl):

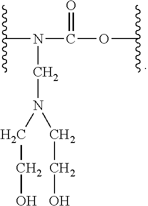 [SMILES: *OC(=O)N(*)CN(CCO)CCO]

3. The foam of claim 1, wherein the foam is an “IL-modified” PUF comprising at least one urethane linkage functionalized with tetradecyl isocyanate:

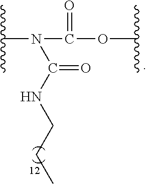 [SMILES: *OC(=O)N(*)C(=O)NCCC]

4. The foam of claim 1, wherein the foam is an “ILO-modified” PUF comprising at least one urethane linkage functionalized with a combination of 2 (oxazolidine-3-yl) and tetradecyl isocyanate:

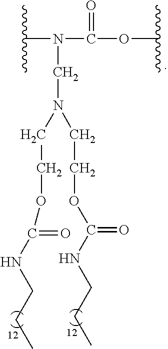 [SMILES: *OC(=O)N(*)CN(CCOC(=O)NCCC)CCOC(=O)NCCC]

5. The foam of claim 1, wherein the polyurethane is a post-consumer polyurethane.

6. The foam of claim 1, wherein the foam is an open-cell foam or a closed-cell foam.

7. The foam of claim 1, wherein the polyurethane is an aliphatic polyurethane or an aromatic polyurethane.

8. The foam of claim 2, wherein the foam comprises:
an oil absorption capacity of about 20.0 g/g to about 60.0 g/g; and
a water absorption capacity of about 15 g/g to about 40 g/g.

9. The foam of claim 3, wherein the foam comprises:
an oil absorption capacity of about 10 g/g to about 35 g/g; and
a water absorption capacity of less than about 0.1 g/g to about 7.5 g/g.

10. The foam of claim 4, wherein the foam comprises:
an oil absorption capacity of about 30 g/g to about 60 g/g; and
a water absorption capacity of about 10 g/g to about 40 g/g.

11. A method of functionalizing a polyurethane foam, the method comprising:
submerging the foam in 2-(oxazolidine-3-yl) or tetradecyl isocyanate; and
heating the submerged foam to about 50° C. to about 90° C. for about 0.5 hours to about 24 hours.

12. The method of claim 11, wherein the foam is a post-consumer foam.

13. The method of claim 11, wherein the polyurethane is an aliphatic polyurethane or an aromatic polyurethane.

14. The method of claim 11, wherein the foam is submerged in 2-(oxazolidine-3-yl), thereby producing an “O-modified” PUF comprising at least one urethane linkage functionalized with 2 (oxazolidine-3-yl):

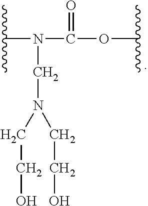 [SMILES: *OC(=O)N(*)CN(CCO)CCO]

15. The method of claim 11, wherein the foam is submerged in tetradecyl isocyanate, thereby producing an “IL-modified” PUF comprising at least one urethane linkage functionalized with tetradecyl isocyanate:

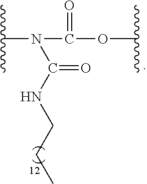 [SMILES: *OC(=O)N(*)C(=O)NCCC]

16. The method of claim 14, further comprising:
rinsing and drying the O-modified PUF; and
submerging the foam in tetradecyl isocyanate, thereby producing an “ILO-modified” PUF comprising at least one urethane linkage functionalized with a combination of 2 (oxazolidine-3-yl) and tetradecyl isocyanate:

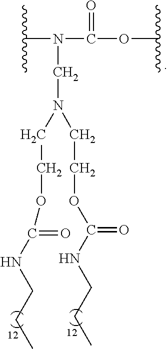 [SMILES: *OC(=O)N(*)CN(CCOC(=O)NCCC)CCOC(=O)NCCC]

17. A method of oil remediation, the method comprising:
submerging a surface-modified polyurethane foam (PUF) in a liquid composition comprising an oil, wherein the surface-modified PUF comprises a polyurethane foam functionalized with 2-(oxazolidine-3-yl), tetradecyl isocyanate, or a combination thereof; and
removing the surface-modified PUF, thereby removing the oil from the liquid composition.

18. The method of claim 17, further comprising compressing or squeezing the foam to release the oil from the foam, thereby reactivating the foam.

19. The method of claim 17, wherein the polyurethane foam is a post-consumer polyurethane foam.

20. The method of claim 19, wherein the post-consumer polyurethane foam is a mattress.
